(19) United States
(12) Patent Application Publication
(10) Pub. No.: US 2021/0365166 A1
(43) Pub. Date: Nov. 25, 2021

(54) SUBSTRATE AND SENSING METHOD THEREOF, TOUCH PANEL AND DISPLAY DEVICE

(71) Applicant: BOE Technology Group Co., Ltd., Beijing (CN)

(72) Inventors: Ping Zhang, Beijing (CN); Xue Dong, Beijing (CN); Jing Lv, Beijing (CN); Haisheng Wang, Beijing (CN); Xiaoliang Ding, Beijing (CN); Wei Liu, Beijing (CN); Xueyou Cao, Beijing (CN); Pengpeng Wang, Beijing (CN); Yanling Han, Beijing (CN); Chihjen Cheng, Beijing (CN); Pinchao Gu, Beijing (CN); Yunke Qin, Beijing (CN); Yuzhen Guo, Beijing (CN)

(21) Appl. No.: 16/333,631

(22) PCT Filed: Jul. 4, 2018
(86) PCT No.: PCT/CN2018/094498

§ 371 Date: Mar. 15, 2019

(30) Foreign Application Priority Data
Sep. 14, 2017 (CN) 201710829241.0

(51) Int. Cl. G06F 3/041; G06F 3/044

(52) U.S. Cl. CPC G06F 3/04144; G06F 2203/04106; G06F 3/0446

(57) ABSTRACT

The disclosure provides a substrate and a sensing method thereof, a touch panel and a display device. The substrate comprises at least two sensing layers, wherein any two of the at least two sensing layers are a first sensing layer and a second sensing layer, respectively; and, the first sensing layer comprises an array of first sensing units, and the second sensing layer comprises an array of second sensing units, any one of the first sensing units within a sensing region is overlapped with more than one of the second sensing units, and any one of the second sensing units within the sensing region is overlapped with more than one of the first sensing units.

### CROSS-REFERENCE TO RELATED APPLICATION

This application claims priority to Chinese Patent Application No. 201710829241.0, filed on Sep. 14, 2017 and entitled “SUBSTRATE AND SENSING METHOD THEREOF, TOUCH PANEL AND DISPLAY DEVICE”, the entire contents of which are incorporated herein by reference.

### TECHNICAL FIELD

The present disclosure relates to a substrate and a sensing method thereof, a touch panel and a display device.

### BACKGROUND

During the manufacturing of a sensor on a platy structure, sandwich structures used as sensing units are often arranged in an array in a same layer to perform a sensing measurement of a corresponding physical quantity according to signals obtained by the sensing units at each location. On this basis, a smaller and denser arrangement of sensing units can realize a higher resolution; however, the actual upper resolution limit of products is limited by process conditions, and high-resolution products require higher-standard manufacturing devices and more precise and complex manufacturing processes, which is very difficult to realize.

### SUMMARY

The present disclosure provides a substrate and a sensing method thereof, a touch panel and a display device.

In a first aspect, there is provided a substrate, comprising at least two sensing layers, each of which comprises an array of sensing units, the substrate further comprising a sensing region, at least one portion of each of the sensing layers is in the sensing region, and any two of the at least two sensing layers are a first sensing layer and a second sensing layer, respectively; wherein the first sensing layer comprises an array of first sensing units, the second sensing layer comprises an array of second sensing units, any one of the first sensing units within the sensing region is overlapped with more than one of the second sensing units, and any one of the second sensing units within the sensing region is overlapped with more than one of the first sensing units.

In a possible implementation, the array of sensing units included in each of the at least two sensing layers are identical in at least one of the following aspects: the shape of each sensing unit, the size of each sensing unit, the central distance between two adjacent sensing units, and the arrangement mode of sensing units.

In a possible implementation, the array of sensing units included in each of the at least two sensing layers are identical in the shape of each sensing unit, the size of each sensing unit, the central distance between two adjacent sensing units and the arrangement mode of sensing units.

In a possible implementation, the at least two sensing layers are arranged in parallel in at least one direction, wherein any direction of the at least one direction is an arrangement direction of a sensing unit in one of the sensing layers, an interval between the at least two sensing layers in the any direction is d/N, the d is a central distance between two adjacent sensing units in the any direction in the sensing layer, and N is the number of the sensing layers.

In a possible implementation, the first sensing layer has a plurality of intersection areas having a congruent shape, and each of the intersection areas is an area with a minimum size enclosed by orthographic projections of a boundary of the array of first sensing units and boundaries of the arrays of sensing units in other sensing layers on the first sensing layer.

In a possible implementation, the sensing layer comprises a sensing material layer, a first electrode layer and a second electrode layer, the first electrode layer and the second layer are on two side surfaces of the sensing material layer, respectively, and at least one of the first electrode layer and the second electrode layer has a pattern corresponding to the array of sensing units included in the sensing layer in which the electrode layer is.

In a possible implementation, the substrate comprises at least four sensing layers, wherein the at least four sensing layers comprise at least one group of a third sensing layer and a fourth sensing layer that share the same second electrode layer; wherein the first electrode layer in the third sensing layer has a pattern corresponding to an array of sensing units included in the third sensing layer; the first electrode layer in the fourth sensing layer has a pattern corresponding to an array of sensing units included in the fourth sensing layer; and the second electrode layer shared by the third sensing layer and the fourth sensing layer covers the sensing region.

In a possible implementation, the array of sensing units included in each of the at least two sensing layers are identical in the shape of each sensing unit, the size of each sensing unit, the central distance between two adjacent sensing units and the arrangement mode of sensing units; the at least two sensing layers are arranged in parallel in at least one direction, wherein any direction of the at least one direction is an arrangement direction of a sensing unit in one of the sensing layers, an interval between the at least two sensing layers in the any direction is d/N, the d is a central distance between two adjacent sensing units in the any direction in the sensing layer, and N is the number of the sensing layers; the sensing layer comprises a sensing material layer, a first electrode layer and a second electrode layer, the first electrode layer and the second layer are on two side surfaces of the sensing material layer, respectively, and at least one of the first electrode layer and the second electrode layer has a pattern corresponding to the array of sensing units included in the sensing layer in which the electrode layer is; the substrate comprises at least four sensing layers, wherein the at least four sensing layers comprise at least one group of a third sensing layer and a fourth sensing layer that share a same second electrode layer; and the first electrode layer in the third sensing layer has a pattern corresponding to an array of sensing units included in the third sensing layer, the first electrode layer in the fourth sensing layer has a pattern corresponding to an array of sensing units included in the fourth sensing layer, and the second electrode layer shared by the third sensing layer and the fourth sensing layer covers the sensing region.

In a possible implementation, the substrate further comprises at least one insulating material layer, each of which is between two of the sensing layers adjacent to each other in a thickness direction of the substrate.

In a possible implementation, a material forming the sensing material layer comprises at least one of a piezoelectric material, a piezoresistive material and a photosensitive semiconductor material.

In a second aspect, the present disclosure further provides a touch panel, comprising a substrate, wherein the substrate comprises at least two sensing layers, each of which comprises an array of sensing units, the substrate further comprises a sensing region, at least one portion of each of the sensing layers is in the sensing region, any two of the at least two sensing layers are a first sensing layer and a second sensing layer, respectively, wherein the first sensing layer comprises an array of first sensing units, the second sensing layer comprises an array of second sensing units, any one of the first sensing units within the sensing region is overlapped with more than one of the second sensing units, and any one of the second sensing units within the sensing region is overlapped with more than one of the first sensing units.

In a possible implementation, the array of sensing units included in each of the at least two sensing layers are identical in at least one of the following aspects: the shape of each sensing unit, the size of each sensing unit, the central distance between two adjacent sensing units, and the arrangement mode of sensing units.

In a possible implementation, the array of sensing units included in each of the at least two sensing layers are identical in the shape of each sensing unit, the size of each sensing unit, the central distance between two adjacent sensing units and the arrangement mode of sensing units.

In a possible implementation, the at least two sensing layers are arranged in parallel in at least one direction, wherein any direction of the at least one direction is an arrangement direction of a sensing unit in one of the sensing layers, an interval between the at least two sensing layers in the any direction is d/N, the d is a central distance between two adjacent sensing units in the any direction in the sensing layer, and N is the number of the sensing layers.

In a possible implementation, the first sensing layer has a plurality of intersection areas having a congruent shape, and each of the intersection areas is an area with a minimum size enclosed by orthographic projections of a boundary of the array of first sensing units and boundaries of the arrays of sensing units in other sensing layers on the first sensing layer.

In a possible implementation, the sensing layer comprises a sensing material layer, a first electrode layer and a second electrode layer, the first electrode layer and the second layer are on two side surfaces of the sensing material layer, respectively, and at least one of the first electrode layer and the second electrode layer has a pattern corresponding to the array of sensing units included in the sensing layer in which the electrode layer is.

In a third aspect, the present disclosure further provides a display device, comprising any of the above substrates.

In a fourth aspect, the present disclosure further provides a display device, comprising any of the above touch panels.

In a fifth aspect, the present disclosure further provides a sensing method applied to any of the above substrates, wherein the substrate comprises at least two sensing layers, each of which comprises an array of sensing units, the substrate further comprises a sensing region, at least one portion of each of the sensing layers is in the sensing region, any two of the at least two sensing layers are a first sensing layer and a second sensing layer, respectively, wherein the first sensing layer comprises an array of first sensing units, the second sensing layer comprises an array of second sensing units, any one of the first sensing units within the sensing region is overlapped with more than one of the second sensing units, and any one of the second sensing units within the sensing region is overlapped with more than one of the first sensing units. The method comprises: acquiring sensing signals respectively corresponding to each of the sensing layers; and integrating the sensing signals respectively corresponding to each of the sensing layers to obtain a sensing result corresponding to coordinates of each location in the sensing region; wherein the minimum location distance of the coordinates of the location is less than the central di stance between two adjacent sensing units in any array of the sensing units.

In a possible implementation, the substrate is used for realizing pressure sensing in a pressure touch, and the sensing signal comprises any one of a signal indicating whether a sensing unit is subjected to pressure and a signal indicating the value of pressure to which a sensing unit is subjected.

### BRIEF DESCRIPTION OF THE DRAWINGS

FIG. 1 is a schematic structural diagram of a substrate according to embodiments of the present disclosure;

FIG. 2 is a schematic diagram of distribution of sensing layers in a substrate according to embodiments of the present disclosure;

FIG. 3 is a schematic diagram of realization of single-point sensing by a substrate according to embodiments of the present disclosure;

FIG. 4 is a schematic diagram of realization of region sensing by a substrate according to embodiments of the present disclosure;

FIG. 5 is a schematic diagram of distribution of sensing layers in a substrate in a thickness direction according to embodiments of the present disclosure;

FIG. 6 is a schematic diagram of distribution of sensing layers in a substrate in an implementation according to embodiments of the present disclosure;

FIG. 7 is a schematic diagram of distribution of sensing layers in a substrate in another implementation according to embodiments of the present disclosure;

FIG. 8 is a schematic diagram of distribution of sensing layers in a substrate in yet another implementation according to embodiments of the present disclosure;

FIG. 9 is a schematic structural diagram of a substrate in a thickness direction according to embodiments of the present disclosure;

FIG. 10 is a schematic structural diagram of a substrate in a thickness direction according to embodiments of the present disclosure; and

FIG. 11 is a flowchart of a sensing method for a substrate according to embodiments of the present disclosure.

### DETAILED DESCRIPTION

To make the concepts, technical solutions and advantages of the present disclosure clearer, the implementations of the present disclosure will be further described below in detail with reference to the accompanying drawings. Apparently, the embodiments described hereinafter are some but not all of the embodiments of the present disclosure. Based on the embodiments of the present disclosure, all other embodiments obtained by a person of ordinary skill in the art without creative effort shall fall into the protection scope of the present disclosure. Unless otherwise defined, the technical or scientific terms used herein should be constructed as having the general meaning understood by a person of ordinary skill in the art of the present disclosure. The word “first”, “second” or the like used herein do not indicate any order, quantity or importance, and are intended to distinguish different components. The word “comprise/comprising” or the like means that an element or object before this word encompasses elements or objects and equivalents thereof listed after this word, and does not exclude other elements or objects. The word “connected to” or “connected with” is not limited to a physical or mechanical connection, and may include an electrical connection which may be direct or indirect.

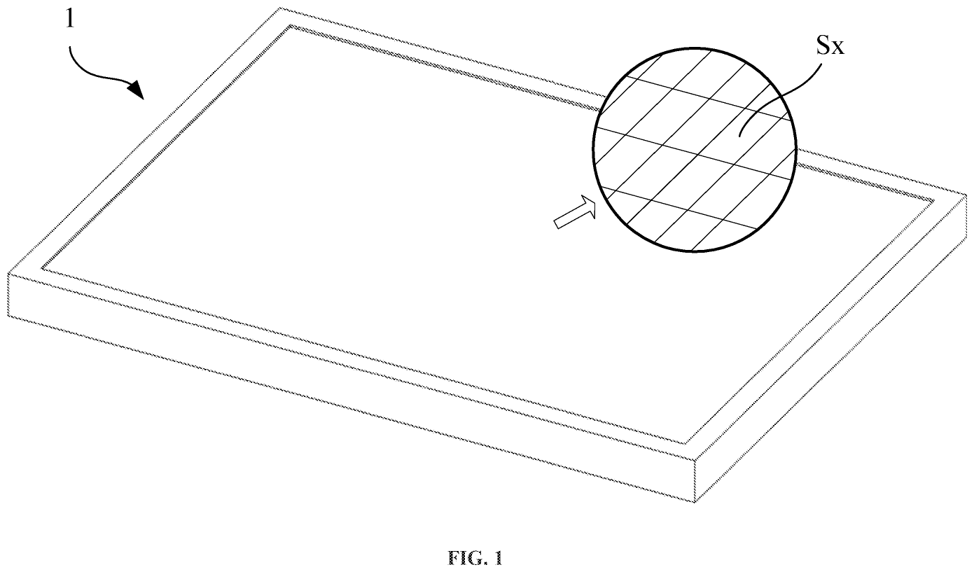

FIG. 1 is a schematic diagram of an application scenario of a substrate according to embodiments of the present disclosure. Referring to FIG. 1, the substrate is arranged in a display device 1 as a portion of the display device 1. The display device 1 may be any product or component having a display function, such as a display panel, a mobile phone, a tablet computer, a TV set, a display, a notebook computer, a digital photo frame or a navigator. The substrate has several sensing units Sx arranged in an array, and all the sensing units Sx form a sensing region of the substrate. Each of the sensing units Sx can output a sensing signal upon sensing an external physical signal such as heat, a change in electric field, pressure, illumination or shading, so that the substrate can realize the sensing of a corresponding physical signal or physical quantity based on the acquisition and processing of the sensing signals in the sensing region. Each sensing unit Sx inside the substrate may include a sensing material layer and an electrode layer. Corresponding to the array arrangement of the sensing units Sx, the sensing material layer and the electrode layer have respective patterns. Thus, the sensing material layer in each sensing unit Sx generates a touch sensing signal during a touch operation, the electrode layer can transmit the touch sensing signal obtained by each sensing unit Sx to a signal output terminal at an edge of the substrate, and an external circuit can be connected to this signal output terminal to receive and process the touch sensing signal, thus realizing the touch sensing function of the display device.

It is to be noted that boundary lines between the sensing units Sx shown in FIG. 1 are reference lines for schematic purpose, and it is unnecessary to correspondingly provide objects or object boundaries in the substrate. The application scenario shown in FIG. 1 is merely an example for explaining an alternative application scenario of the substrate, and the shape and construction of the substrate and the applied product may not be limited to the forms described above.

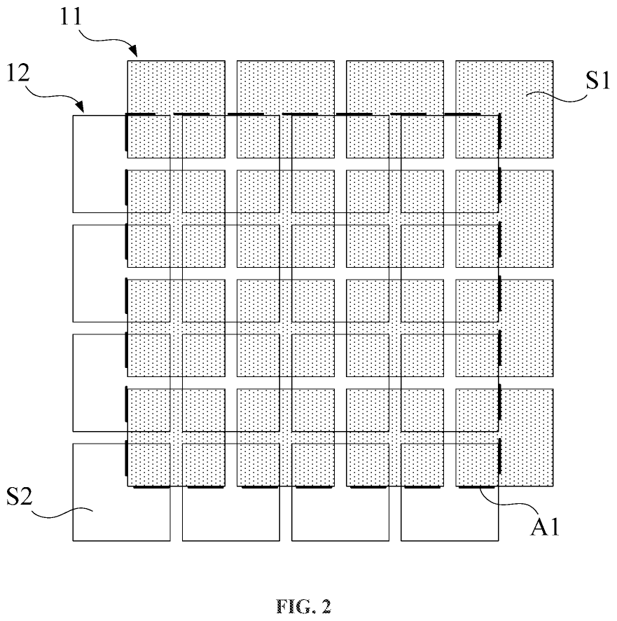

FIG. 2 is a schematic diagram of distribution of sensing layers in the substrate according to embodiment of the present disclosure. FIG. 2 is shown from the top view of the substrate, and other structures except for the sensing layers are omitted. Referring to FIG. 2, the substrate includes a first sensing layer 11 and a second sensing layer 12. In a sensing region A1 included in the substrate, the first sensing layer 11 and the second sensing layer 12 are at least partially located in the sensing region A1. (For example, FIG. 2 shows the case where the intersection area between the first sensing layer 11 and the second sensing layer 12 just covers the sensing region A1). As shown in FIG. 2, the first sensing layer 11 includes an array of first sensing units S1 (a 4×4 array is schematically illustrated in FIG. 2), and the second sensing layer 12 includes an array of second sensing units S2 (a 4×4 array is schematically illustrated in FIG. 2). For ease of description, for the array in each sensing layer, the uppermost row in FIG. 2 is designated as the first row and the leftmost column is designated as the first column.

It can be seen that, for each of the first sensing units S1 in the sensing region A1, more than one of the second sensing units S2 is overlapped with this first sensing unit S1 (in the embodiments of the present disclosure, when there is an intersection area between the orthographic projections of two sensing units in two different sensing layers on any sensing layer, the two sensing units are overlapped with each other; and for each of the second sensing units S2 in the sensing region A1, more than one of the first sensing units S1 is overlapped with this second sensing unit S2. It is to be noted that, generally, sensing units located on a boundary of the sensing region in each sensing layer rarely participate in the realization of the sensing function, so these sensing units may not be required to overlap with more than one sensing unit in another sensing layer. In an example, for the second sensing unit S2 in the first row and the fourth column of the second sensing layer 12 in the sensing region A1 shown in FIG. 2, four first sensing units S1 at the upper right corner of the first sensing layer 11 are overlapped with this second sensing unit S2; and, for the first sensing unit S1 in the fourth row and the first column of the first sensing layer 11 in the sensing region A1 shown in FIG. 2, four second sensing units S2 at the lower left coiner of the second sensing layer 12 are overlapped with this first sensing unit S1. It is to be noted that, for example, only a portion of the first sensing unit S1 in the first row and the fourth column of the first sensing layer 11 shown in FIG. 2 is located in the sensing region A1, so it is not a first sensing units S1 in the sensing region A1.

Based on this, the sensing location of a physical signal can be independently reflected by the sensing signal acquired by the first sensing layer 11 and the sensing signal acquired by the second sensing layer 12, so that a higher-resolution sensing result can be obtained by comprehensively considering the both.

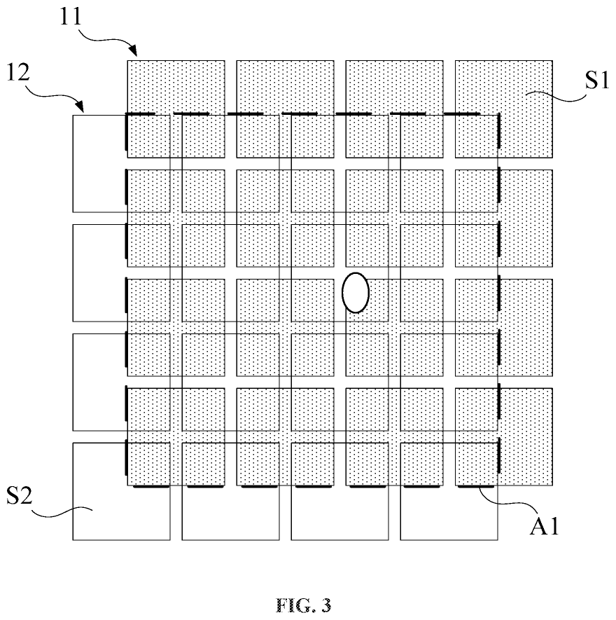

As shown in FIG. 3, when the sensing location is a point (denoted by a circle in FIG. 3) in the sensing region A1 of the substrate, it can be determined by the sensing signals acquired by the first sensing layer 11 that the sensing location is located within a range of the first sensing unit S1 in the third row and the third column, and it can be determined by the sensing signals acquired by the second sensing layer 12 that the sensing location is located within a range of the second sensing unit S in the second row and the third column. Therefore, by compressively considering the both, it can be determined that the second location is located within a range where the two sensing units are overlapped with each other, that is, the size covered by the circle portion in FIG. 3 occupies about one quarter of the square of the sensing unit. It can be known that, compared with the first sensing layer 11 or second sensing layer 12 alone, the minimum resolution area for the single-point sensing location in this embodiment is reduced by about 4 times, while the density of sensing units in the manufacturing process remains unchanged, that is, a higher resolution is realized under the same process conditions.

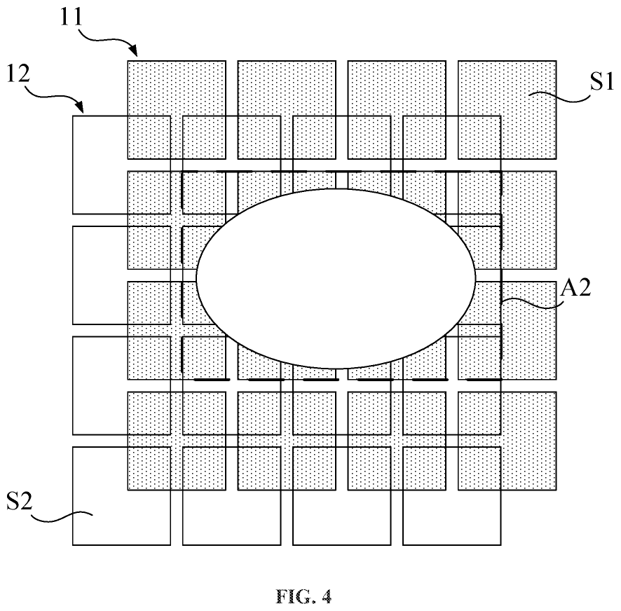

As shown in FIG. 4, when the sensing location is a region (denoted by a circle in FIG. 4) in the sensing region A1 of the substrate, it can be determined by the sensing signals acquired by the first sensing layer 11 that the sensing location covers the first sensing units S1 in two middle rows of the first sensing layer 11, and it can be determined by the sensing signals acquired by the second sensing layer 12 that the sensing location covers the second sensing units S2 in three rows and three columns at the upper right corner of the second sensing layer 12. Therefore, by comprehensively considering the both, the range covered by the sensing location can be reduced to a detection region A2 shown by a box in FIG. 4 (denoted by a dashed box in FIG. 4, the detection region A2 in FIG. 4 is the intersection area between the middle two rows of first sensing units S1 in the first sensing layer 11 and the three rows and three columns of second sensing units S2 at the top right corner of the second sensing layer 12). It can be known that, compared with the 2×4 range independently determined by the first sensing layer 11 and the 3×3 range independently determined by the second sensing layer 12, in this embodiment, a smaller 2×3 range can be obtained, that is, a coverage range of the sensing location can be identified more accurately, while keeping the density of sensing units in the manufacturing process unchanged, that is, a higher resolution is realized under the same process conditions.

It can be known that, in this embodiment of the present disclosure, based on the arrangement of the first sensing layer and the second sensing layer, by using the characteristic that different locations on the first sensing units can be distinguished by the overlapped second sensing units and different locations on the second sensing units can be distinguished by the overlapped first sensing units, a higher resolution can be realized under the same process conditions, the process difficulty of high-resolution products can be reduced, and better product performances can be realized. It should be understood that the realization of a higher resolution in the same process and the reduction of the process difficulty at the same resolution can be realized alternatively or simultaneously, but the increase of the resolution and the reduction of the process difficulty can both improve the product performance in respective aspects and can be selected according to the application requirements during implementation.

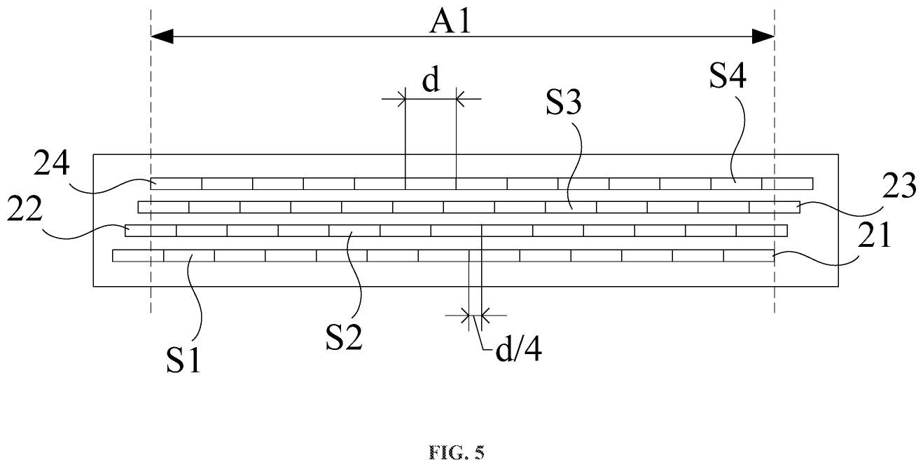

FIG. 5 is a schematic diagram of distribution of sensing layers of a substrate in a thickness direction according to embodiments of the present disclosure. Referring to FIG. 5, other structures expect for the sensing layers are omitted in the thickness direction of the substrate, and the substrate includes a first sensing layer 21, a second sensing layer 22, a third sensing layer 23 and a fourth sensing layer 24. Throughout a sensing region A1 of the substrate, the first sensing layer 21, the second sensing layer 22, the third sensing layer 23 and the fourth sensing layer 24 are distributed. As shown in FIG. 5, the first sensing layer 21 includes an array of first sensing units S1, the second sensing layer 22 includes an array of second sensing units S2, the third sensing layer 23 includes an array of third sensing units S3, and the fourth sensing layer 24 includes an array of fourth sensing units S4. Any two of the sensing layers satisfy the following relationship: within the sensing region A1, any sensing unit in one sensing layer in the sensing region A1 is overlapped with more than one sensing unit in another sensing layer; and vice versa. For example, the second sensing layer 22 and the third sensing layer 23 satisfy the above relationship: any second sensing unit S2 in the sensing region A1 is overlapped with more than one third sensing unit S3 (For example, in the horizontal direction of the structure shown in FIG. 5, the second sensing unit S2 is overlapped with the third sensing unit S3), and any third sensing unit S3 in the sensing region A1 is overlapped with more than one second sensing unit S2.

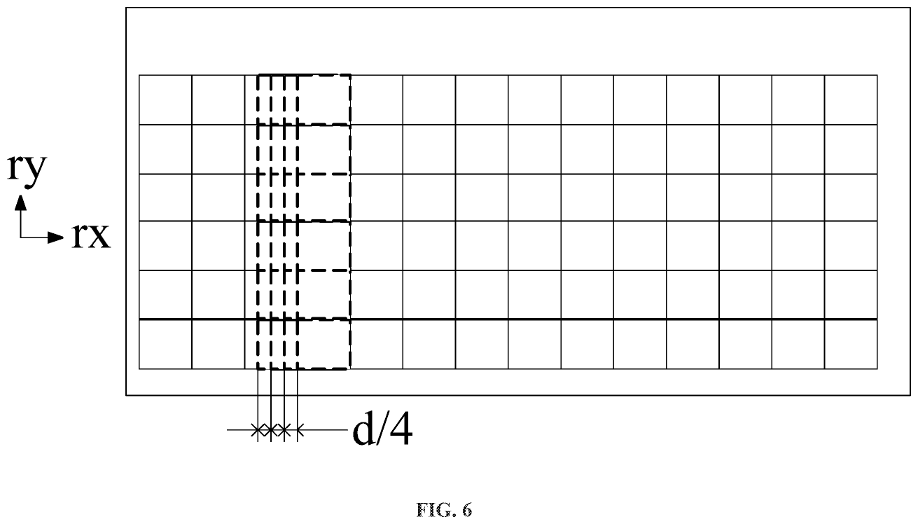

In an implementation, the distribution of the sensing layers in the substrate shown in FIG. 5 when the substrate is viewed from its top is shown in FIG. 6. Referring to FIGS. 5 and 6, the direction from left to right in FIG. 5 is a first direction rx shown in FIG. 6. The first sensing units S1, the second sensing units S2, the third sensing units S3 and the fourth sensing units S4 each has a length of d in the first direction rx, and the first sensing layer 21, the second sensing layer 22, the third sensing layer 23 and the fourth sensing layer 24 are successively staggered by a length of d/4 in the first direction rx (that is, the first sensing layer 21, the second sensing layer 22, the third sensing layer 23 and the fourth sensing layer 24 are arranged in parallel in the first direction rx at an interval of d/4). Based on this, this implementation can achieve the effect of improving the resolution of the sensing location in the first direction rx: in the case where the sensing location is a point, four sensing units, corresponding to the sensing location, in the four sensing layers have a common region (the common region may be an overlapped region of four sensing units in four sensing layers respectively that receive sensing location pressure) representing the sensing location, and the length of the common region in the first direction rx is d/4; and, in the case where the sensing location is a region, the minimum resolution of the region boundary in the first direction rx can reach d/4. Therefore, in an application scenario where a higher sensing location resolution is required in a certain direction, the technical effects of at least one of realizing a higher resolution under the same process conditions and reducing the process difficulty of a high-resolution product can be achieved.

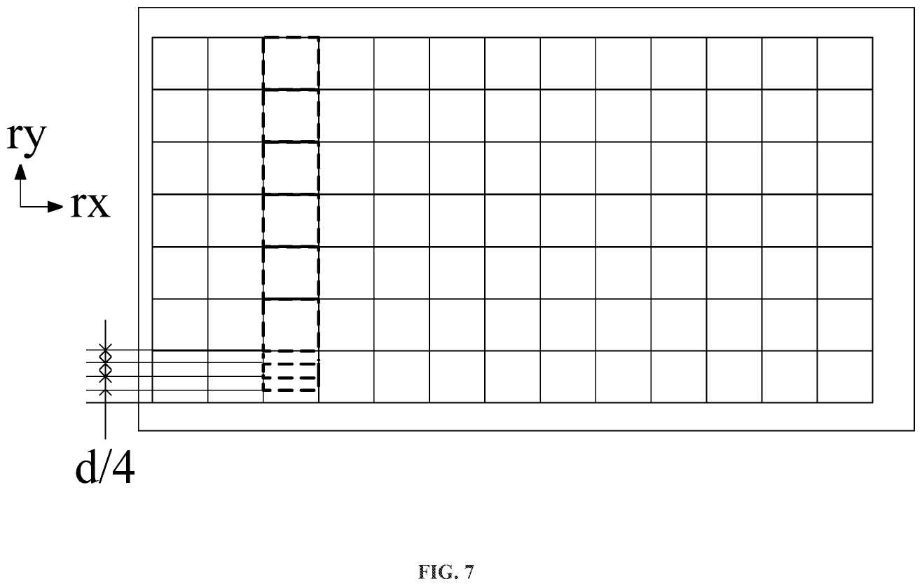

In another implementation, the distribution of the sensing layers in the substrate shown in FIG. 5 when the substrate is viewed from its top is shown in FIG. 7. Referring to FIGS. 5 and 7, the direction from left to right in FIG. 5 is a second direction ry shown in FIG. 7. The first sensing units S1, the second sensing units S2, the third sensing units S3 and the fourth sensing units S4 each has a length of d in the second direction ry, and the first sensing layer 21, the second sensing layer 22, the third sensing layer 23 and the fourth sensing layer 24 are successively staggered by a length of d/4 in the second direction ry (that is, the first sensing layer 21, the second sensing layer 22, the third sensing layer 23 and the fourth sensing layer 24 are arranged in parallel in the second direction ry at an interval of d/4). Based on this, this implementation can achieve the effect of improving the resolution of the sensing location in the second direction ry: in the case where the sensing location is a point, four sensing units, corresponding to the sensing location, in the four sensing layers have a common region representing the sensing location, and the length of the common region in the second direction ry is d/4; and, in the case where the sensing location is a region, the minimum resolution of the region boundary in the second direction ry can reach d/4. Therefore, in an application scenario where a higher sensing location resolution is required in a certain direction, the technical effects of at least one of realizing a higher resolution under the same process conditions and reducing the process difficulty of a high-resolution product can be achieved.

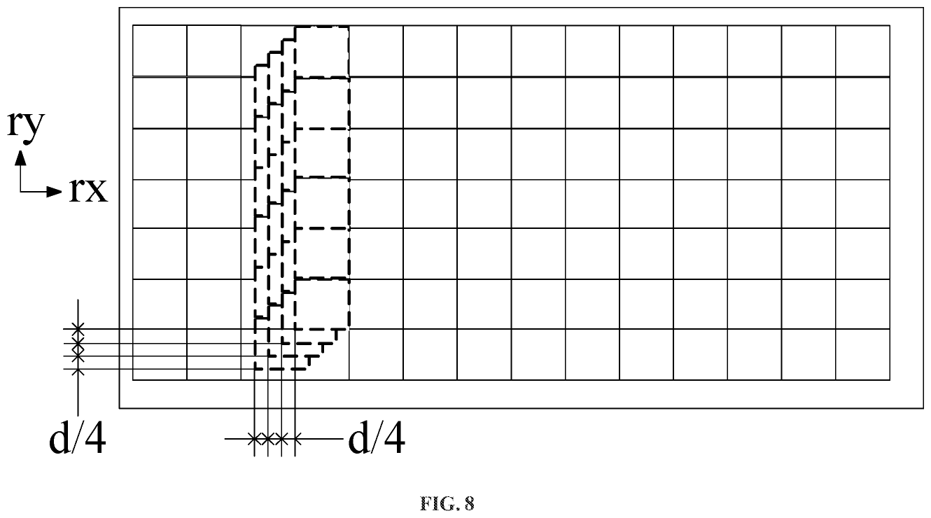

In another implementation, the distribution of the sensing layers in the substrate shown in FIG. 5 when the substrate is viewed from its top is shown in FIG. 8. Referring to FIGS. 5 and 8, the section of the substrate in each of the first direction rx and the second direction ry shown in FIG. 8 has a structure shown in FIG. 5. The first sensing units S1, the second sensing units S2, the third sensing units S3 and the fourth sensing units S4 each has a length of d in both the first direction rx and the second direction ry, and the first sensing layer 21, the second sensing layer 22, the third sensing layer 23 and the fourth sensing layer 24 are successively staggered by a length of d/4 in the first direction pc and also successively staggered by a length of d/4 in the second direction ry, so that the sensing layers are arranged in a direction of an angular bisector of a right angle between the first direction rx and the second direction ry as a whole. That is, the first sensing layer 21, the second sensing layer 22, the third sensing layer 23 and the fourth sensing layer 24 are arranged in parallel in both the first direction rx and the second direction ry at an interval of d/4. Based on this, this implementation can achieve the technical effects of at least one of realizing a higher resolution under the same process conditions and reducing the process difficulty of a high-resolution product in a way similar to that shown in FIGS. 3 and 4.

It can be known from the above examples that the number of sensing layers of the substrate can be any value greater than 2. That is, the substrate includes at least two sensing layers, each of which comprises an array of sensing units, the substrate includes a sensing region, and at least one portion of each of the sensing layers is located in the sensing region; and any two of the at least two sensing layers are a first sensing layer and a second sensing layer, respectively; the first sensing layer includes an array of first sensing units, and the second sensing layer includes an array of second sensing units; and, any one of the first sensing units in the sensing region is overlapped with more than one of the second sensing units, and any one of the second sensing units in the sensing region is overlapped with more than one of the first sensing units. Based on this, since different locations in the first sensing units can be distinguished by the overlapped second sensing units, and different locations in the second sensing units can be distinguished by the overlapped first sensing units, generally, the larger the number of the sensing layers is, the higher the resolution that can be achieved is. However, considering that an increase in the number of sensing layers will increase the overall thickness of the substrate, increase the number of steps in the process, and cause a decrease in the yield or the like, the number of sensing layers can be set for example to be less than or equal to S. In addition, it is to be noted that the substrates described above are examples of the embodiments of the present disclosure, and the location, area and boundary shape of the sensing region on the substrate, the internal construction of the substrate and the like can be set within a possible range according to the sensing requirements of the product. The shape of the substrate and the shape of each of the sensing units can be, for example, square, rectangular, triangular, circular, elliptic, rhombic, or the like. The size of each of the sensing units and the central distance between the sensing units can be set by selecting an appropriate multiple based on the display pixels; and, based on the row/column arrangement, the arrangement mode of the sensing units can be staggering in odd and even rows or staggering in odd and even columns, or the sensing units can be arranged, for example, in form of a triangular grid or a rhombic grid. In addition, the settings of any substrate described above in any aspect may not be limited to the implementations mentioned above.

In the substrate shown in FIGS. 2 to 6, all the sensing layers are identical in the shape of each sensing unit, the size of each sensing unit, the central distance between sensing units, the arrangement mode of sensing units and the like, so that the sensing layers can be manufactured using the same mask, which is conducive to the simplification of the manufacturing process of the substrate and the products on which the substrate is located. Moreover, the calculation process of receiving and processing sensing signals to sense a physical signal or a physical quantity becomes simpler, that is, it is helpful to reduce the design difficulty of algorithms and improve the processing efficiency of algorithms. In addition, the array of sensing units included in each of the sensing layers of any substrate described above can also be identical in at least one of the following aspects: the shape of each sensing unit, the size of each sensing unit, the central distance between two adjacent sensing units and the arrangement mode of sensing units. No matter the arrays of sensing units are identical in which aspect or aspects, the effect of simplifying the process and the algorithm can be achieved to a certain extent. However, the array of sensing units included in each of the sensing layers of any substrate may be different in all of these aspects, or same in some of these aspects, which is not limited in the embodiments of the present disclosure.

Taking the substrates shown in FIGS. 5 to 8 as an example, on the basis that the array of sensing units included in each of the at least two sensing layers are identical in the shape of each sensing unit, the size of each sensing unit, the central distance between two adjacent sensing units and the arrangement mode of sensing units, the arrays individually included in the at least two sensing layers can also be arranged in parallel in an arrangement direction of at least one sensing unit. That is, the at least two sensing layers are arranged in parallel in at least one direction, and any direction of the at least one direction is the arrangement direction of the sensing units in a sensing layer. The at least two sensing layers are arranged at an interval of d/N in the any direction, where the d is the central distance between two adjacent sensing units in the any direction in the sensing layer, and the N is the number of the sensing layers. For example, the arrays in the sensing layers of the substrate shown in FIGS. 5 and 6 are arranged in parallel at an interval of d/4 in a row arrangement direction (i.e., the first direction rx) of the sensing units; the arrays in the sensing layers of the substrate shown in FIGS. 5 and 7 are arranged in parallel at an interval of d/4 in a column arrangement direction (i.e., the second direction ry) of the sensing units; and, the arrays in the sensing layers of the substrate shown in FIGS. 5 and 8 are arranged in parallel at an interval of d/4 in both the row arrangement direction (i.e., the first direction ix) and the column arrangement direction (i.e., the second direction ry) of the sensing units. Of course, in other cases where N=3, N=5, N=6, N=7, N=8 or the sensing units are arranged in other forms such as a triangular grid or a rhombic grid, the parallel arrangement of each sensing layer can be set in the above way. Based on this, the eventually realized uniform distribution of units having the minimum location resolution within the sensing region can be closer to the single-layer high-resolution product in terms of effect.

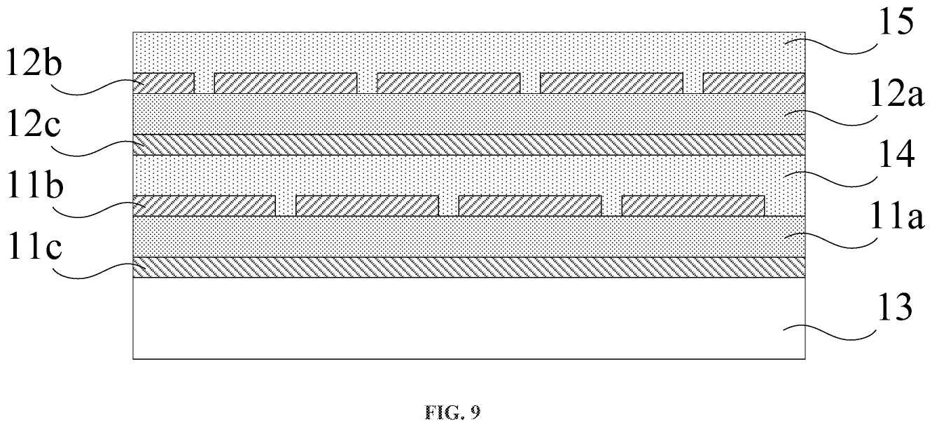

FIG. 9 is a schematic structural diagram of a substrate in a thickness direction according to embodiments of the present disclosure. Referring to FIGS. 9 and 2, in a section of the substrate shown in FIG. 2 in a row direction, the first sensing layer 11 includes a sensing material layer 11a, a first electrode layer 11b and a second electrode layer 11c, with the first electrode layer 11b and the second electrode layer 11c located on surfaces on two sides of the sensing material layer 11a, respectively; and, the second sensing layer 12 includes a sensing material layer 12a, a first electrode layer 12b and a second electrode layer 12c, with the first electrode layer 12b and the second electrode layer 12c located on surfaces on two sides of the sensing material layer 12a, respectively. The first electrode layer 11b has a pattern corresponding to the array of sensing units included in the sensing layer 11 (the pattern corresponding to the array of sensing units may be deemed as the pattern same as the array of sensing units), and the second electrode layer 12b has a pattern corresponding to the array of sensing units included in the sensing layer 12. Furthermore, the first sensing layer 11 is arranged on a bottom plate 13 and covered by a first insulating layer 14; and, the second sensing layer 12 is arranged on the first insulating layer 14 and covered by an encapsulation layer 15.

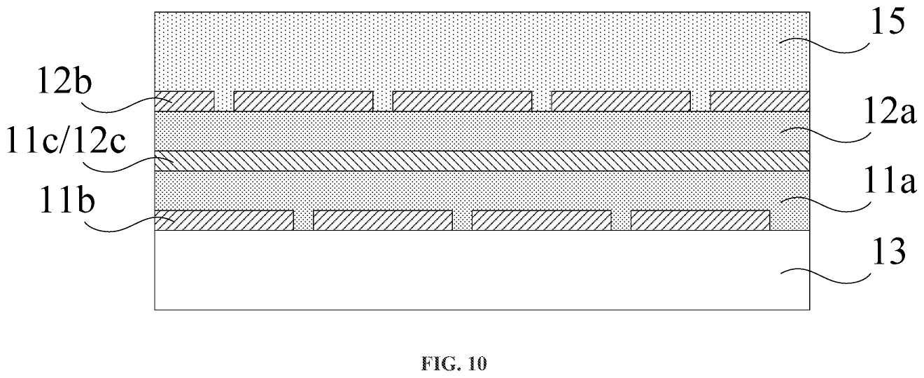

FIG. 10 is a schematic structural diagram of a substrate in a thickness direction according to embodiments of the present disclosure. Referring to FIGS. 10 and 2, in a section of the substrate shown in FIG. 2 in a row direction, the first sensing layer 11 and the second sensing layer 12 shares the same second electrode layer 11c/12c, the first electrode layer 11b in the first sensing layer 11 has a pattern corresponding to the array of sensing units included in the first sensing layer 11, the first electrode layer 12b in the second sensing layer 12 has a pattern corresponding to the array of sensing units included in the second sensing layer, and the second electrode layer 11c/12c shared by the first sensing layer 11 and the second sensing layer 12 covers the whole sensing region A1. It can be known that the first sensing layer shown in FIG. 10 (the first sensing layer in FIG. 10 includes a first electrode layer 11b, a sensing material layer 11a and a second electrode layer 11c) is turned over in a thickness direction with respect to the structure shown in FIG. 9, and the turned-over second electrode layer 11c is simultaneously used as the second electrode layer 12c of the second sensing layer 12 (the second electrode layer in FIG. 10 includes a first electrode layer 12b, a sensing material layer 12a and a second electrode layer 12c). Thus, the first insulating layer is omitted, and both the first sensing layer and the second sensing layer are arranged on the bottom plate 13 and covered by the encapsulation layer 15. Taking this as an example, for any substrate described above, every two sensing layers adjacent to each other in the thickness direction can be set as one group, the sensing layers in each group are arranged in the same manner as the two sensing layers shown in FIG. 10, and the groups are separated by insulating layers. Accordingly, the number of the insulating layers is reduced, the thickness of the substrate is decreased, and the manufacturing process is simplified.

It can be seen from FIG. 3 and FIG. 4 that the first sensing layer has a plurality of intersection areas having a congruent shape (the definition of congruent shape is: when the shapes and sizes of two patterns are the same respectively, the two patterns have the congruent shape), and each of the intersection areas is an area with a minimum size enclosed by orthographic projections of a boundary of the array of first sensing units and boundaries of the arrays of sensing units in other sensing layers on the first sensing layer. As shown in FIG. 3 or FIG. 4, the rectangular block with a minimum size enclosed by orthographic projections of boundaries of the array of first sensing units on the first sensing layer 11 is the intersection area. The intersection area has the minimum size which can be distinguished. The congruent intersection areas can enable the same resolution sensed at different positions of the substrate to be the same, which is convenient to determine the position of the touch panel.

Taking the structures shown in FIGS. 9 and 10 as an example, for any substrate described above, each sensing layer can include a sensing material layer, a first electrode layer and a second electrode layer, the first electrode layer and the second electrode layer are located on surfaces on two sides of the sensing material layer, respectively, and at least one of the first electrode layer and the second electrode layer has a pattern corresponding to the array of sensing units included in the sensing layer in which the electrode layer is, thereby realizing the setting of the corresponding array of sensing units. In other possible implementations, in addition to the possibility of manufacturing the electrode layers on two side surfaces of the sensing material layer in each sensing layer into the same pattern as the array of sensing units, it is also possible that the electrode layers on two sides of the sensing material layer in each sensing layer are respectively manufactured into a layer of strip-shaped electrodes arranged in the row direction and a layer of strip-shaped electrodes arranged in the column direction to form a sensing unit at each intersection of the rows and columns of the strip-shaped electrodes, so as to form a pattern corresponding to the array of sensing units, thereby realizing the setting of the corresponding array of sensing units.

In order to avoid the mutual interference between electrodes of two sensing layers adjacent to each other in the thickness direction, at least one insulating material layer may be provided, and each insulating material layer is located between the two sensing layers adjacent to each other in the thickness direction. Exemplarily, the insulating material layer may be the first insulating layer 14 shown in FIG. 9. Moreover, the material forming the sensing material layer in each sensing layer in any substrate described above may be at least one selected from a piezoelectric material, a piezoresistive material and a photosensitive semiconductor material, so that the sensing material layer can coordinate with the proper electrical signals on at least one of the first electrode layer and the second electrode layer to realize the generation and acquisition of sensing signals. For example, it is possible that the sensing material layers in all the sensing layers in the substrate are formed from the piezoelectric material, so that a reference voltage can be applied to the second electrode layer, and the electric quantity on the first electrode layer is detected and released within each sensing period to obtain a detected pressure value of each sensing unit of each sensing layer. The distribution of pressure in the sensing region within the corresponding sensing period is obtained by comprehensively processing each detected pressure value.

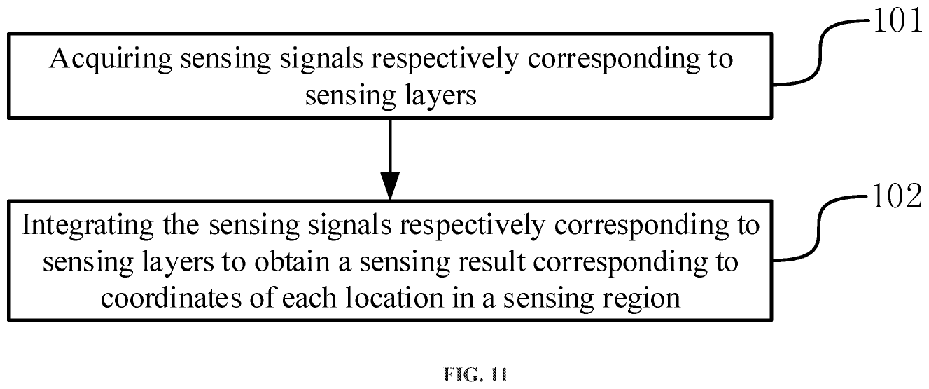

FIG. 11 is a flowchart of a sensing method applied to a substrate according to embodiments of the present disclosure. Referring to FIG. 11, corresponding to any of the substrates described above, the corresponding sensing method includes the following steps.

In step 101, sensing signals respectively corresponding to sensing layers are acquired.

In step 102, the sensing signals respectively corresponding to sensing layers are integrated to obtain a sensing result corresponding to coordinates of each location in a sensing region.

The minimum location distance of the coordinates of the location is less than the central distance between two adjacent sensing units in any array of the sensing units.

In an example in which the sensing units in each sensing layer are arranged in rows and columns, a sensing signal of each sensing unit of each sensing layer can be acquired in an output format of (row number, column number, sensed value) in step 101. In step 102, all sensed values less than a validity detection threshold among the output results are set to zero (for example, if the sensed values are in a range of 0 to 255, 15 can be preset as a validity detection threshold), and then each output result is superposed onto each value in its mapped range in a reduction matrix. The reduction matrix is formed by arranging the numerical values of the sensed values corresponding to all minimum resolution units in the sensing region, wherein the location of each minimum resolution unit in the sensing region is the location of the corresponding numerical value in the reduction matrix, the size of the corresponding numerical value is the sum of the sensed values of all sensing units including this minimum resolution unit, and the initial value is zero. Finally, each numerical value in the range mapped into the reduction matrix of the sensing units corresponding to the sensed value of zero is set to zero.

On the basis that the scenario shown in FIG. 3 is taken as an example, the direct from the top down is used as a row direction, and the direction from left to right is used as a column direction. By acquiring sensing signals respectively corresponding to the first sensing layer 11 and the second sensing layer 12, it can be obtained that the output result of the first sensing layer 11 is (3, 3, 255), and the output result of the second sensing layer 12 is (2, 3, 255). Thus, in the 7/7 reduction matrix corresponding to the sensing region A1, the numerical values at four locations (4, 5), (4, 6), (5, 5) and (5, 6) mapped by the output result (3, 3, 255) of the first sensing layer 11 are superposed with 255 on the basis of the initial value 0, and the numerical values at four locations (3, 4), (3, 5), (4, 4) and (4, 5) mapped by the output result (2, 3, 255) of the second sensing layer 12 are superposed with 255 on the basis of the original values, so that the numerical value at the location (4, 5) is 500 and the numerical values at the locations (4, 6), (5, 5), (5, 6), (3, 4), (3, 5) and (4, 4) are 255. Finally, each numerical value in the range mapped into the reduction matrix of all the sensing units having the sensed value of zero in the first sensing layer 11 and the second sensing layer 12 is set to zero, that is, all numerical values except for the numerical value at the location (4, 5) in the reduction matrix are set to zero, so that a reduction matrix having only the numerical value of 500 at the location (4, 5) is eventually obtained and output as the result of sensing.

As an illustrative example, when the substrate is used for realizing pressure sensing in a pressure touch, the sensing signal may be a signal indicating whether a sensing unit is subjected to pressure (for example, the above sensed values of 0 to 128 are output as 0, the sensed values of 129 to 255 are output as 1, and the subsequent operation is performed according to the rules for the logic operation of digital signals) or a signal indicating the value of pressure to which a sensing unit is subjected. The pressure sensing in a pressure touch can be realized by either of the two ways.

Based on the same inventive concept, an embodiment of the present disclosure provides a touch substrate, including any one of the substrates described above. Any one of the substrates described above can also be directly used as a touch substrate or an intermediate product in the manufacturing process. The touch substrate in this embodiment can achieve the technical effects of at least one of realizing a higher resolution under the same process conditions and reducing the process difficulty of a high-resolution product.

Based on the same inventive concept, an embodiment of the present disclosure provides a display device, including any one of the substrates described above or any one of the touch panels described above. The display device in this embodiment of the present disclosure can be any product or component having a display function, such as a display panel, a mobile phone, a tablet computer, a TV set, a display, a notebook computer, a digital photo frame or a navigator. The display device in this embodiment can achieve the technical effects of at least one of realizing a higher resolution under the same process conditions and reducing the process difficulty of a high-resolution product.

The foregoing descriptions are only embodiments of the present disclosure, and are not intended to limit the present disclosure. Within the spirit and principles of the disclosure, any modifications, equivalent substitutions, improvements, etc., are within the protection scope of the present disclosure.

What is claimed is:

1. A substrate, comprising at least two sensing layers, each of which comprises an array of sensing units, the substrate further comprising a sensing region, wherein at least one portion of each of the sensing layers is in the sensing region, any two of the at least two sensing layers are a first sensing layer and a second sensing layer, respectively,
wherein the first sensing layer comprises an array of first sensing units, the second sensing layer comprises an array of second sensing units, any one of the first sensing units within the sensing region is overlapped with more than one of the second sensing units, and any one of the second sensing units within the sensing region is overlapped with more than one of the first sensing units.

2. The substrate according to claim 1, wherein the array of sensing units included in each of the at least two sensing layers are identical in at least one of the following aspects:
the shape of each sensing unit,
the size of each sensing unit,
the central distance between two adjacent sensing units, and
the arrangement mode of sensing units.

3. The substrate according to claim 2, wherein the array of sensing units included in each of the at least two sensing layers are identical in the shape of each sensing unit, the size of each sensing unit, the central distance between two adjacent sensing units and the arrangement mode of sensing units.

4. The substrate according to claim 1, wherein the sensing layer comprises a sensing material layer, a first electrode layer and a second electrode layer, the first electrode layer and the second layer are on two side surfaces of the sensing material layer, respectively, and at least one of the first electrode layer and the second electrode layer has a pattern corresponding to the array of sensing units included in the sensing layer in which the electrode layer is.

5. The substrate according to claim 4, comprising at least four sensing layers, wherein the at least four sensing layers comprise at least one group of a third sensing layer and a fourth sensing layer that share the same second electrode layer,
the first electrode layer in the third sensing layer has a pattern corresponding to an array of sensing units included in the third sensing layer,
the first electrode layer in the fourth sensing layer has a pattern corresponding to an array of sensing units included in the fourth sensing layer, and
the second electrode layer shared by the third sensing layer and the fourth sensing layer covers the sensing region.

6. The substrate according to claim 1, further comprising at least one insulating material layer, each of which is between two of the sensing layers adjacent to each other in a thickness direction of the substrate.

7. The substrate according to claim 4, wherein a material forming the sensing material layer comprises at least one of a piezoelectric material, a piezoresistive material and a photosensitive semiconductor material.

8. A touch panel, comprising a substrate, wherein the substrate comprises at least two sensing layers, each of which comprises an array of sensing units, the substrate further comprises a sensing region, at least one portion of each of the sensing layers is in the sensing region, any two of the at least two sensing layers are a first sensing layer and a second sensing layer, respectively, wherein the first sensing layer comprises an array of first sensing units, the second sensing layer comprises an array of second sensing units, any one of the first sensing units within the sensing region is overlapped with more than one of the second sensing units, and any one of the second sensing units within the sensing region is overlapped with more than one of the first sensing units.

9. A display device, comprising the substrate according to claim 1.

10. A sensing method applied to a substrate, wherein the substrate comprises at least two sensing layers, each of which comprises an array of sensing units, the substrate further comprises a sensing region, at least one portion of each of the sensing layers is in the sensing region, any two of the at least two sensing layers are a first sensing layer and a second sensing layer, respectively, wherein the first sensing layer comprises an array of first sensing units, the second sensing layer comprises an array of second sensing units, any one of the first sensing units within the sensing region is overlapped with more than one of the second sensing units, and any one of the second sensing units within the sensing region is overlapped with more than one of the first sensing units, the method comprising:
acquiring sensing signals respectively corresponding to each of the sensing layers; and
integrating the sensing signals respectively corresponding to each of the sensing layers to obtain a sensing result corresponding to coordinates of each location in the sensing region;
wherein the minimum location distance of the coordinates of the location is less than the central distance between two adjacent sensing units in any array of the sensing units.

11. The method according to claim 10, wherein the substrate is used for realizing pressure sensing in a pressure touch, and the sensing signal comprises any one of a signal indicating whether a sensing unit is subjected to pressure and a signal indicating the value of pressure to which a sensing unit is subjected.

12. The substrate according to claim 3, wherein the at least two sensing layers are arranged in parallel in at least one direction, wherein any direction of the at least one direction is an arrangement direction of a sensing unit in one of the sensing layers, an interval between the at least two sensing layers in the any direction is d/N, the d is a central distance between two adjacent sensing units in the any direction in the sensing layer, and N is the number of the sensing layers.

13. The substrate according to claim 1, wherein the first sensing layer has a plurality of intersection areas having a congruent shape, and each of the intersection areas is an area with a minimum size enclosed by orthographic projections of a boundary of the array of first sensing units and boundaries of the arrays of sensing units in other sensing layers on the first sensing layer.

14. The substrate according to claim 1, wherein the array of sensing units included in each of the at least two sensing layers are identical in the shape of each sensing unit, the size of each sensing unit, the central distance between two adjacent sensing units and the arrangement mode of sensing units;
the at least two sensing layers are arranged in parallel in at least one direction, wherein any direction of the at least one direction is an arrangement direction of a sensing unit in one of the sensing layers, an interval between the at least two sensing layers in the any direction is d/N, the d is a central distance between two adjacent sensing units in the any direction in the sensing layer, and N is the number of the sensing layers;
the sensing layer comprises a sensing material layer, a first electrode layer and a second electrode layer, the first electrode layer and the second layer are on two side surfaces of the sensing material layer, respectively, and at least one of the first electrode layer and the second electrode layer has a pattern corresponding to the array of sensing units included in the sensing layer in which the electrode layer is;
the substrate comprises at least four sensing layers, wherein the at least four sensing layers comprise at least one group of a third sensing layer and a fourth sensing layer that share a same second electrode layer; and
the first electrode layer in the third sensing layer has a pattern corresponding to an array of sensing units included in the third sensing layer, the first electrode layer in the fourth sensing layer has a pattern corresponding to an array of sensing units included in the fourth sensing layer, and the second electrode layer shared by the third sensing layer and the fourth sensing layer covers the sensing region.

15. The touch panel according to claim 8, wherein the array of sensing units included in each of the at least two sensing layers are identical in at least one of the following aspects: the shape of each sensing unit, the size of each sensing unit, the central distance between two adjacent sensing units, and the arrangement mode of sensing units.

16. The touch panel according to claim 15, wherein the array of sensing units included in each of the at least two sensing layers are identical in the shape of each sensing unit, the size of each sensing unit, the central distance between two adjacent sensing units and the arrangement mode of sensing units.

17. The touch panel according to claim 16, wherein the at least two sensing layers are arranged in parallel in at least one direction, wherein any direction of the at least one direction is an arrangement direction of a sensing unit in one of the sensing layers, an interval between the at least two sensing layers in the any direction is d/N, the d is a central distance between two adjacent sensing units in the any direction in the sensing layer, and N is the number of the sensing layers.

18. The touch panel according to claim 8, wherein the first sensing layer has a plurality of intersection areas having a congruent shape, and each of the intersection areas is an area with a minimum size enclosed by orthographic projections of a boundary of the array of first sensing units and boundaries of the arrays of sensing units in other sensing layers on the first sensing layer.

19. The touch panel according to claim 8, wherein the sensing layer comprises a sensing material layer, a first electrode layer and a second electrode layer, the first electrode layer and the second layer are on two side surfaces of the sensing material layer, respectively, and at least one of the first electrode layer and the second electrode layer has a pattern corresponding to the array of sensing units included in the sensing layer in which the electrode layer is.

20. A display device, comprising the touch panel according to claim 8.
